(19) United States
(12) Patent Application Publication
(10) Pub. No.: US 2007/0026937 A1
(43) Pub. Date: Feb. 1, 2007

(54) Gaming machine

(75) Inventor: Keika Yokoyama, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/491,979

(22) Filed: Jul. 25, 2006

(30) Foreign Application Priority Data
Jul. 26, 2005 (JP) 2005-216265

(51) Int. Cl. A63F 13/00

(52) U.S. Cl. 463/25; 463/20

(57) ABSTRACT

A gaming machine includes: an image display device; a processor that performs a process for providing a player a game by controlling the image display device to display a progress of the game; and an operation unit that allows the player to input skip command. The processor performs the process includes: determining whether or not a win by the player occurs in the game; controlling the image display device to perform a game result displaying process for displaying a result of the game in accordance with the determination to allow the player to recognize the result of the determination; and controlling the image display device to cancel performing the game result displaying process before completion thereof, and to start performing a next game, when the skip command is input through the operation unit.

### CROSS-REFERENCE TO THE RELATED APPLICATION(S)

The present application is based upon and claims priority from prior Japanese Patent Application No. 2005-216265, filed on Jul. 26, 2005, the entire contents of which are incorporated herein by reference.

### TECHNICAL FIELD

The present invention relates to a gaming machine such as a slot machine, a Pachi-Slot machine, or a pachinko machine including display device, such as a liquid crystal display, for displaying a result of the game play.

### BACKGROUND

Hitherto, there is provided a gaming machine including display device, such as a liquid crystal display, for displaying the result of the game play and advancing game play using an image displayed on the display device. As examples of such gaming machine, for example, there is provided: a gaming machine for producing variable display as reels displayed as an image on a liquid crystal display (such type of reels will be hereinafter referred to as “video reels”) are rotated or scrolled according to player's operation (video slot machine); and a gaming machine for displaying a card image representing playing cards and changing the card image display to advance the game according to operation input of the player (card gaming machine). In addition, a gaming machine such as a pachinko machine or a Pachi-Slot machine also includes display device and provides a game to the player using images displayed on the display device.

In this kind of gaming machine, various effects such as image effect displayed on display device are produced for the reasons of heightening a sense of expectancy of the player and enhancing the game play desire until the result of the game (for example, in video slot machine, symbol combination when variable display stops; in pachinko machine, symbol stop display state in special symbol game) is displayed. For example, a document JP-A-2002-159687 discloses a pachinko machine for producing effect for enhancing the degree of expectation for a big bonus or flag completion of a bonus game. A document JP-A-2002-126171 discloses a Pachi-Slot machine wherein effects displayed on a display are substantially classified into effects that can be canceled and effects that cannot be canceled and the player can cancel any effect that can be canceled by operating an effect cancel button.

In the gaming machines in the related arts, various effects such as image effect displayed on display device are produced, so that a sense of expectancy of the player can be heightened and the game play desire can be enhanced according to the effects.

However, even if various effects such as image effect are produced, the final result of the game does not always become a win (or a winning combination) (for example, the symbol combination does not become a specific combination, the symbol stop display state does not become a specific stop display state, or the like). Thus, if the player plays a game with any gaming machine in the related arts, the player easily feels that a loss feeling or regret when the result of the game does not become a win (or a winning combination) is large on the rebound after a sense of expectancy is heightened by the effects.

Even if the result of the game finally becomes a win (or a winning combination), it is also possible that the profit obtained by the player from the win (or the winning combination) does not meet player's expectations as the payout of the win (or the winning combination) is small contrary to player's expectations. In such a case, it seems that the effect produced with effort is fruitless for the player.

In addition, if effect is produced in the gaming machines in the related arts, the player can only receive the effect passively and active play of the player is not promoted.

### SUMMARY

According to a first aspect of the invention, there is provided a gaming machine including: an image display device; a processor that performs a process for providing a player a game by controlling the image display device to display a progress of the game; and an operation unit that allows the player to input skip command. The processor performs the process including: determining whether or not a win by the player occurs in the game; controlling the image display device to perform a game result displaying process for displaying a result of the game in accordance with the determination to allow the player to recognize the result of the determination; and controlling the image display device to cancel performing the game result displaying process before completion thereof, and to start performing a next game, when the skip command is input through the operation unit.

According to a second aspect of the invention, there is provided a method for providing a player a game with a gaming machine by controlling an image display device provided on the gaming machine to display a progress of the game. The method includes: determining whether or not a win by the player occurs in the game; controlling the image display device to perform a game result displaying process for displaying a result of the game in accordance with the determination to allow the player to recognize the result of the determination; and controlling the image display device to cancel performing the game result displaying process before completion thereof, and to start performing a next game, when a skip command is input through an operation unit provided on the gaming machine.

According to a third aspect of the invention, there is provided a computer-readable program product for causing a computer provided on a gaming machine for providing a player a game with a gaming machine by controlling an image display device provided on the gaming machine to display a progress of the game. The program product causes the computer to perform the procedure including: determining whether or not a win by the player occurs in the game; controlling the image display device to perform a game result displaying process for displaying a result of the game in accordance with the determination to allow the player to recognize the result of the determination; and controlling the image display device to cancel performing the game result displaying process before completion thereof, and to start performing a next game, when a skip command is input through an operation unit provided on the gaming machine.

### BRIEF DESCRIPTION OF THE DRAWINGS

In the accompanying drawings:

FIG. 1 is a perspective view to show a general configuration of a slot machine of a gaming machine according an embodiment;

FIG. 2 is a block diagram showing an internal configuration of the slot machine;

FIG. 3 is a block diagram to show an example of the internal configuration of a video control circuit;

FIG. 4 is a flowchart to show an operation procedure from the game start to the end;

FIG. 5 is a flowchart to show the operation procedure of base game processing;

FIG. 6 is a flowchart to show the operation procedure of different base game processing;

FIG. 7 is a drawing to show an example of a stop table;

FIG. 8 is a drawing to show an example of a slot game image displayed on the slot machine 1 according the first embodiment;

FIG. 9 is a drawing to show an example of a slot game image displayed after FIG. 8;

FIG. 10 is a drawing to show an example of a slot game image displayed after FIG. 9;

FIG. 11 is a drawing to show an example of a slot game image displayed after FIG. 9;

FIG. 12 is a drawing to show an example of a slot game image displayed on a slot machine 1 according a second embodiment;

FIG. 13 is a drawing to show an example of a slot game image displayed after FIG. 12;

FIG. 14 is a drawing to show an example of a slot game image displayed after FIG. 13; and

FIG. 15 is a drawing to show an example of a slot game image displayed after FIG. 14.

### DETAILED DESCRIPTION

A gaming machine according to the invention will be discussed in detail with reference to the accompanying drawings based on embodiments, which are embodied as a slot machine.

### FIRST EMBODIMENT

General Configuration of Slot Machine

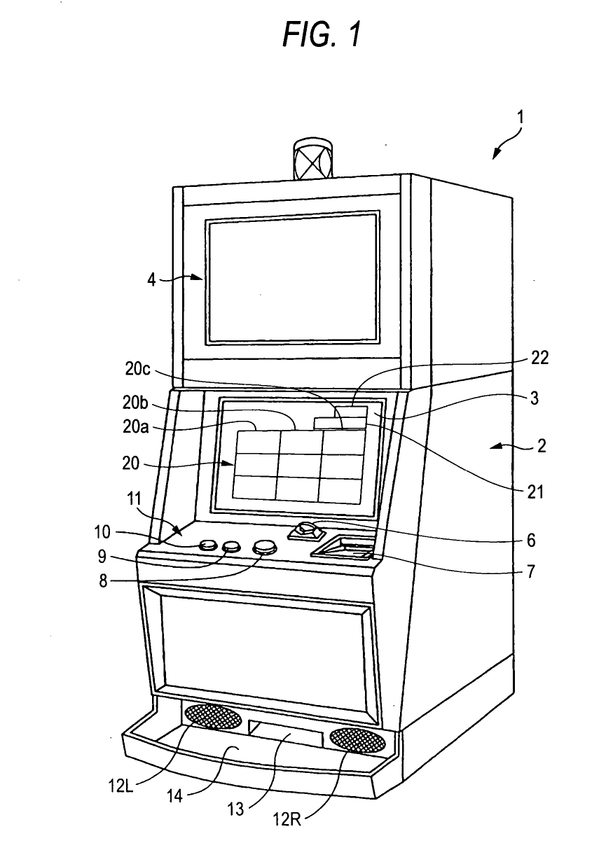

FIG. 1 is a perspective view showing a general configuration of a slot machine 1. The slot machine 1 is a gaming machine according to the embodiment and enables a player to play a variable display game (also called slot game) using variable display images of symbols. The slot machine 1 has a bonus game state for allowing a player to play a bonus game started under a given condition in succession to a base game as well as a base game state for allowing a player to play a base game started unconditionally from the game start, and also enables the player to play a slot game in the bonus game state.

The slot machine 1 is provided with a main display 3 (image display device) including a liquid crystal display on the front of a cabinet 2 and also has a subsidiary display 4 including a liquid crystal display above the main display 3.

The main display 3 has a variable display area 20 that is provided at substantially in the center of a screen of the main display 3. Three symbol display sections 20a, 20b, and 20c are placed in the variable display area 20 from side to side. A scroll display image (reel image displayed as if a mechanical reel rotated) with a plurality of symbols moving from the top to the bottom is displayed on each of the symbol display sections 20a, 20b, and 20c, and the symbols corresponding to first to third reels are displayed. When a slot game is over, a symbol row with three symbols arranged in a longitudinal direction is displayed on each of the symbol display sections 20a, 20b, and 20c. The three symbol rows indicate the result of the game.

The main display 3 displays a skip command input section 21 and a point display section 22 arranged above the symbol display sections 20a, 20b, and 20c. In the slot machine 1, a total of five activated pay lines of three horizontal rows and two diagonal lines can be set according to the three symbol display sections 20a, 20b, and 20c. The number of activated pay lines is changed according to the number of game medium, such as coins and medals, bet by a player on the game (the game medium will be hereinafter referred to as “coins”) or setting using credit (coin and credit information in terms of the number of times a slot game can be performed is referred to as game value information).

An image relevant to a game such as an award table or description of the game is displayed on the subsidiary display 4.

The slot machine 1 has an almost horizontal pedestal portion 11 below the main display 3. The pedestal portion 11 is provided with a coin insertion slot 6, a bill insertion slot 7, a spin switch 8, a 1BET switch 9, and a MAX BET switch 10.

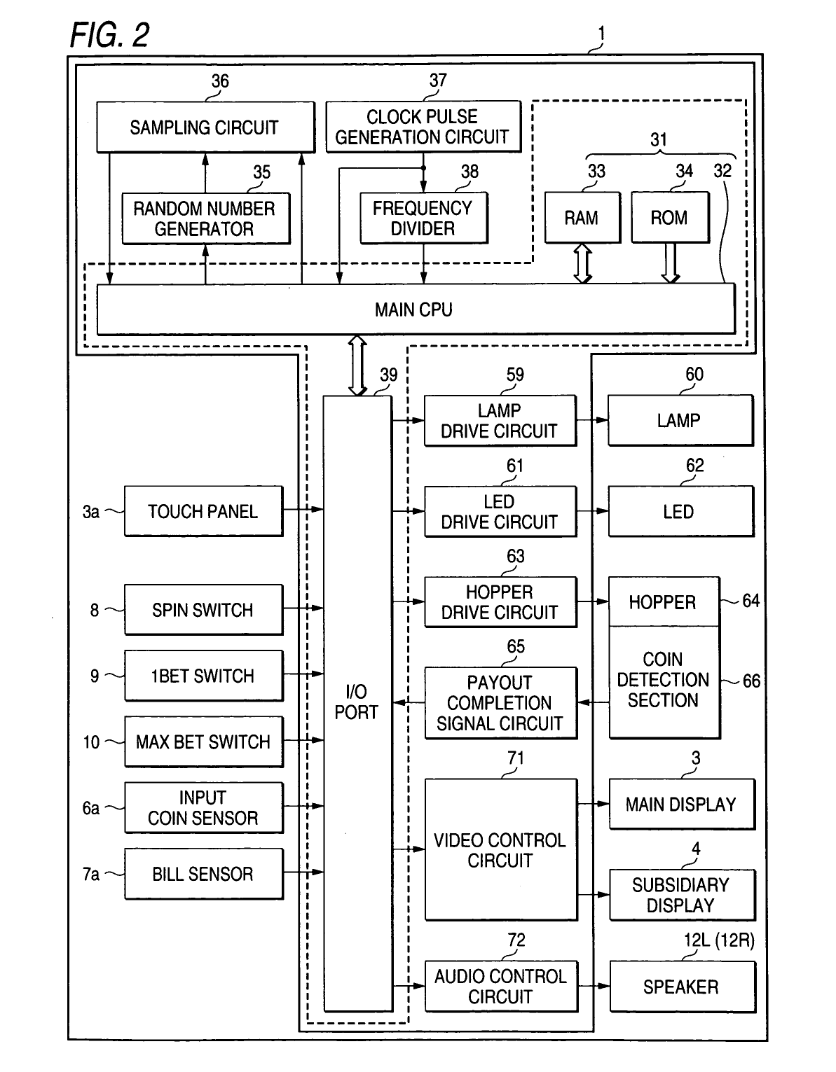

The coin insertion slot 6 is provided for a player to input a coin and has an insertion coin sensor 6a (see FIG. 2) for outputting a signal indicating coin input. The bill insertion slot 7 is provided for a player to input a bill and has a bill sensor 7a (see FIG. 2) for outputting a signal indicating bill insertion. The spin switch 8 is provided for a player to perform operation for displaying variable display images of symbols on the symbol display sections 20a, 20b, 20c, 20d, and 20e and starting a slot game. The 1BET switch 9 is provided for a player to bet one coin by operating the switch once. The MAX BET switch 10 is provided for a player to bet the maximum number of coins that can be bet on one game by operating the switch once.

Further, the slot machine 1 has a coin payout opening 13 and a coin receiving tray 14 for storing paid-out coins. Further, the slot machine 1 is provided with speakers 12L and 12R on the left and the right of the coin payout opening 13.

FIG. 2 is a block diagram of the slot machine 1 showing an internal configuration of the slot machine 1. The slot machine 1 includes a microcomputer 31 (processor).

The microcomputer 31 has a main CPU (Central Processing Unit) 32, RAM (Random Access Memory) 33, and ROM (Read-Only Memory) 34. The main CPU 32 performs a process for providing the player the game by controlling the main display 3 (image display device) to display a progress of the game, in accordance with programs stored in the ROM 34. The main CPU 32 inputs/outputs signals from/to other components via an I/O port 39 for controlling the whole operation of the slot machine 1. Data and a program used for the main CPU 32 to operate are stored in the RAM 33; for example, a random number sampled by a sampling circuit 36 described later is temporarily stored in the RAM 33 after a game starts. The ROM 34 stores the programs performed by the main CPU 32 and permanent data.

The slot machine 1 also has a random number generator 35, the above-mentioned sampling circuit 36, a clock pulse generation circuit 37, and a frequency divider 38. The random number generator 35 operates in accordance with an instruction of the main CPU 32 and generates random numbers in a given range. The sampling circuit 36 extracts any desired random number from among the random numbers generated by the random number generator 35 in accordance with an instruction of the main CPU 32 and inputs the extracted random number to the main CPU 32. The clock pulse generation circuit 37 generates a reference clock to operate the main CPU 32 and the frequency divider 38 inputs a signal provided by dividing the reference clock in a given cycle to the main CPU 32.

Further, the slot machine 1 has a touch panel 3a, a lamp drive circuit 59, a lamp 60, an LED drive circuit 61, LEDs 62, a hopper drive circuit 63, a hopper 64, a payout completion signal circuit 65, and a coin detection section 66. The slot machine 1 also has a video control circuit 71 and a audio control circuit 72.

The touch panel 3a is provided so as to cover the screen of the main display 3 for detecting the position where touched by the player and inputting a position signal corresponding to the detected position to the main CPU 32. Although described later in detail, when the player touches the skip command input section 21, the touch panel 3a inputs skip command to the main CPU 32 and serves as a skip command input unit.

The lamp drive circuit 59 outputs a signal for lighting the lamp 60 to the lamp 60 for blinking the lamp 60 during game progress. As the lamp 60 is blinked, game effect is produced. The LED drive circuit 61 controls blink display of the LEDs 62. The LEDs 62 display the credit count, the acquired number of coins, etc. The hopper drive circuit 63 drives the hopper 64 under the control of the main CPU 32 and the hopper 64 performs the operation for paying out coins from the coin payout opening 13 to the coin receiving tray 14. The coin detection section 66 measures the number of coins paid out by the hopper 64 and sends the data of the measured number of coins to the payout completion signal circuit 65. The payout completion signal circuit 65 inputs the data of the measured number of coins from the coin detection section 66. When the number of coins reaches the setup number, the payout completion signal circuit 65 inputs a signal indicating coin payout completion to the main CPU 32.

The video control circuit 71 controls image display of the main display 3 and the subsidiary display 4 and displays various images of variable display images of symbols, etc., on the main display 3 and the subsidiary display 4.

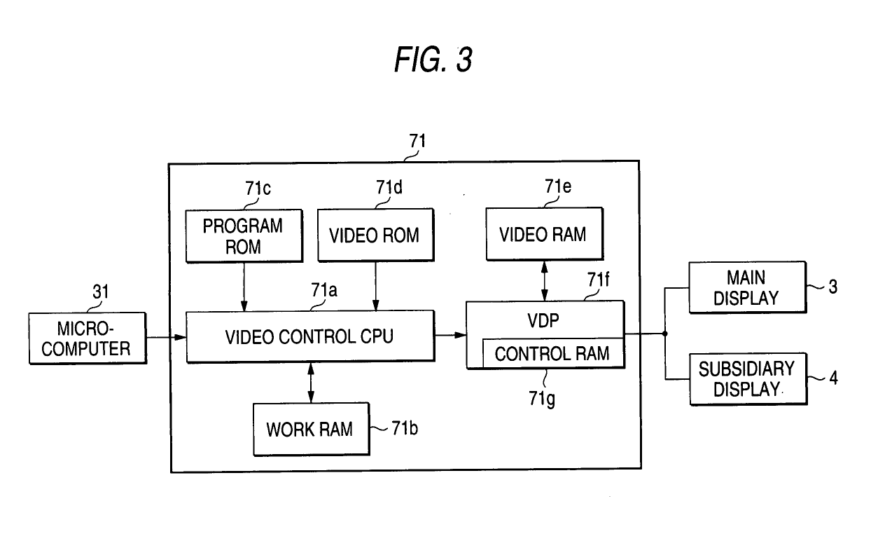

The video control circuit 71 has an video control CPU 71a, work RAM 71b, program ROM 71c, video ROM 71d, video RAM 71e, and a VDP (Video Display Processor) 71f, as shown in FIG. 3.

The video control CPU 71a determines the images to be displayed on the main display 3 and the subsidiary display 4 (variable display images of symbols, etc.,) in accordance with an image control program (concerning display of the main display 3 and the subsidiary display 4) previously stored in the program ROM 71c based on a parameter set in the microcomputer 31. The work RAM 71b is implemented as temporary storage means for the video control CPU 71a to execute the image control program.

The program ROM 71c stores the image control program, various selection tables, etc. The video ROM 71d stores bitmap image data (dot data) for forming images. In the embodiment, the bitmap image data contains symbol image data indicating symbols used with a base game and a bonus game. The video RAM 71e is implemented as temporary storage means for the VDP 71f to form an image. The VDP 71f has control RAM 71g and forms an image responsive to the display of the main display 3 and the subsidiary display 4 determined by the video control CPU 71a and outputs the formed image to the main display 3 and the subsidiary display 4.

The audio control circuit 72 inputs a sound signal for outputting a sound from the speakers 12L and 12R to the speakers 12L and 12R. For example, a sound to augment the game is output from the speakers 12L and 12R at an appropriate timing after the game starts.

Operation of Slot Machine

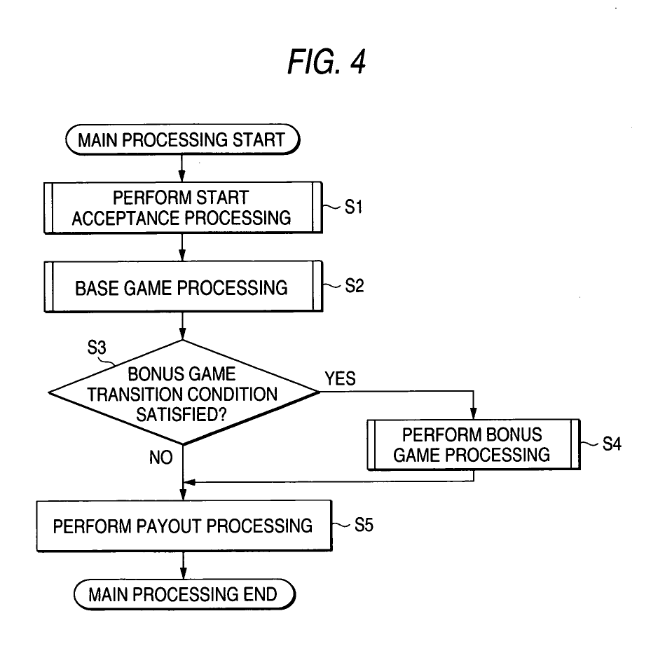

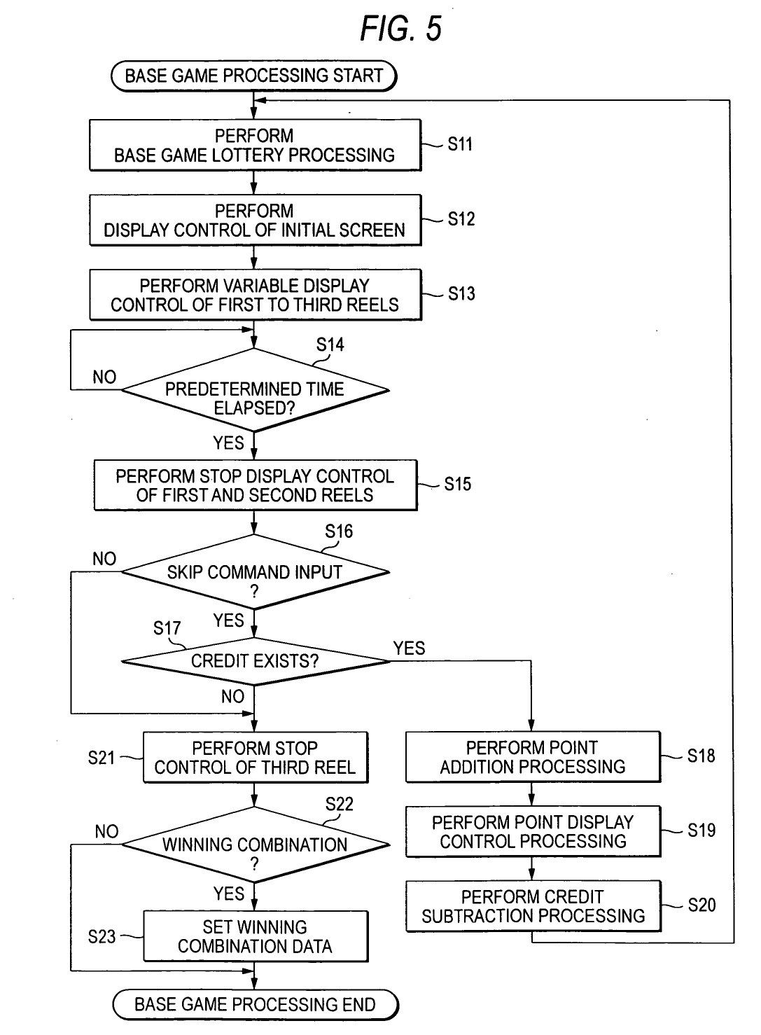

Next, the operation of the slot machine 1 having the described configuration will be discussed with reference to flowcharts of FIGS. 4 and 5. In the slot machine 1, first, base game processing is performed in succession to start acceptance processing and subsequently bonus game processing is performed under a given condition, as shown in FIG. 4.

FIG. 4 is a flowchart to show the operation procedure of main processing from the start to the end of a slot game in the slot machine 1, and FIG. 5 is a flowchart to show the operation procedure of base game processing.

In the slot machine 1, the main CPU 32 serves as a game progress control unit and controls game progress. At this time, in the slot machine 1, when the main processing is started, start acceptance processing is performed at step S1 for starting a game and then base game processing is performed with the game state as the base game state at step S2 and the process proceeds to step S3, as shown in FIG. 4. At step S3, upon reception of the result of base game lottery processing described later in the base game processing at step S2, the main CPU 32 determines whether or not to make a transition to a bonus game state in accordance with a transition condition for causing the game state to make a transition to the bonus game state. Here, if the transition condition is satisfied and it is determined that the game state can make a transition to the bonus game state, the process proceeds to step S4 and then to step S5. If the transition condition is not satisfied, step S4 is skipped and the process proceeds to step S5. At step S5, when a winning combination occurs in the base game or the bonus game, coin payout processing based on setup winning combination data described later (coin payout instruction corresponding to the number of paid-out coins to the hopper drive circuit 63 by the main CPU 32, coin payout by the hopper 64, and signal input from the payout completion signal circuit 65) is performed. Thereafter, the main processing is completed.

First, at step S1 (start acceptance processing), the slot machine 1 accepts operation for starting a slot game from a player under the control of the main CPU 32. The slot machine 1 is configured as a coin-input type gaming machine. Accordingly, in order to start a slot game, first the player inputs coins bet on one game from the coin insertion slot 6 and when credit remains, the player operates the 1BET switch 9 or the MAX BET switch 10. Subsequently, the player operates the spin switch 8 (hereinafter, the operation of the switches will be referred to as “start operation”). As the start operation is performed, a start signal is input from the spin switch 8 to the main CPU 32.

Next, at step S2, base game processing is performed according to the flowchart of FIG. 5. When the base game processing is started, the process proceeds to step S11 and base game lottery processing is performed. In the base game lottery processing, the main CPU 32 serves as symbol determination unit for performing symbol determination processing. In the symbol determination processing, the main CPU 32 determines the symbols (stop symbols) to be displayed stopped in the center of the symbol display sections 20a, 20b, and 20c in the longitudinal direction for each of the symbol display sections 20a, 20b, and 20c as variable display is stopped. During the base game lottery processing in the slot machine 1, the main CPU 32 instructs the video control circuit 71 to display an image for producing game effect on the subsidiary display 4.

In the base game lottery processing, when the main CPU 32 detects start operation of the player based on a start signal, the main CPU 32 instructs the random number generator 35 to generate random numbers in a given range. The main CPU 32 instructs the sampling circuit 36 to extract any desired random number from among the random numbers generated by the random number generator 35. When the random number is extracted, the main CPU 32 sets the random number as a search key, references a symbol determination table (table storing code numbers of symbols and random numbers in association with each other—not shown) stored in the ROM 34, and acquires the code number of the corresponding symbol.

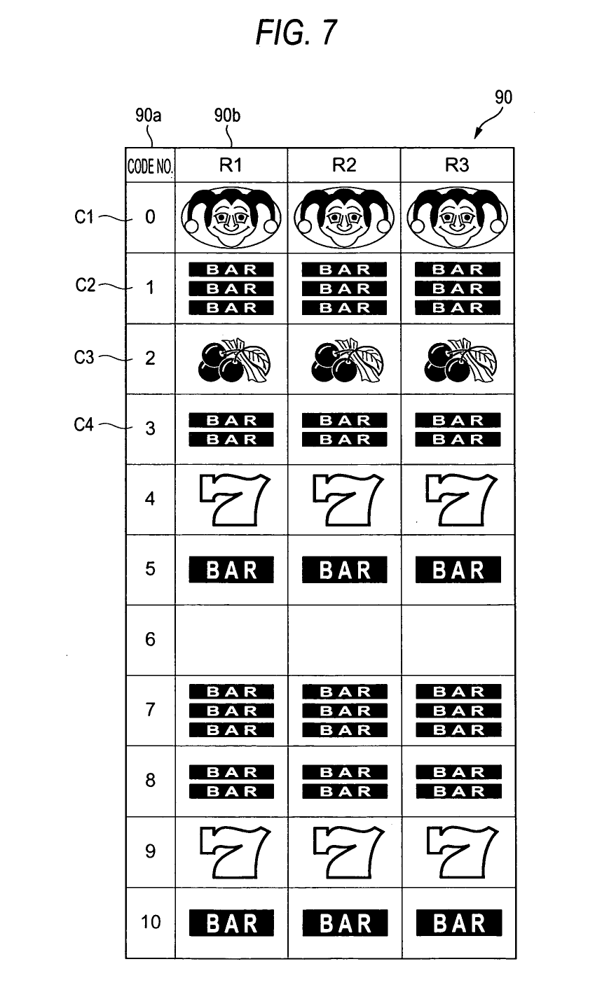

Next, the main CPU 32 sets the acquired code number as a search key, references a stop table 90 shown in FIG. 7, and refers to for the stop symbol on each of the symbol display sections 20a, 20b, and 20c.

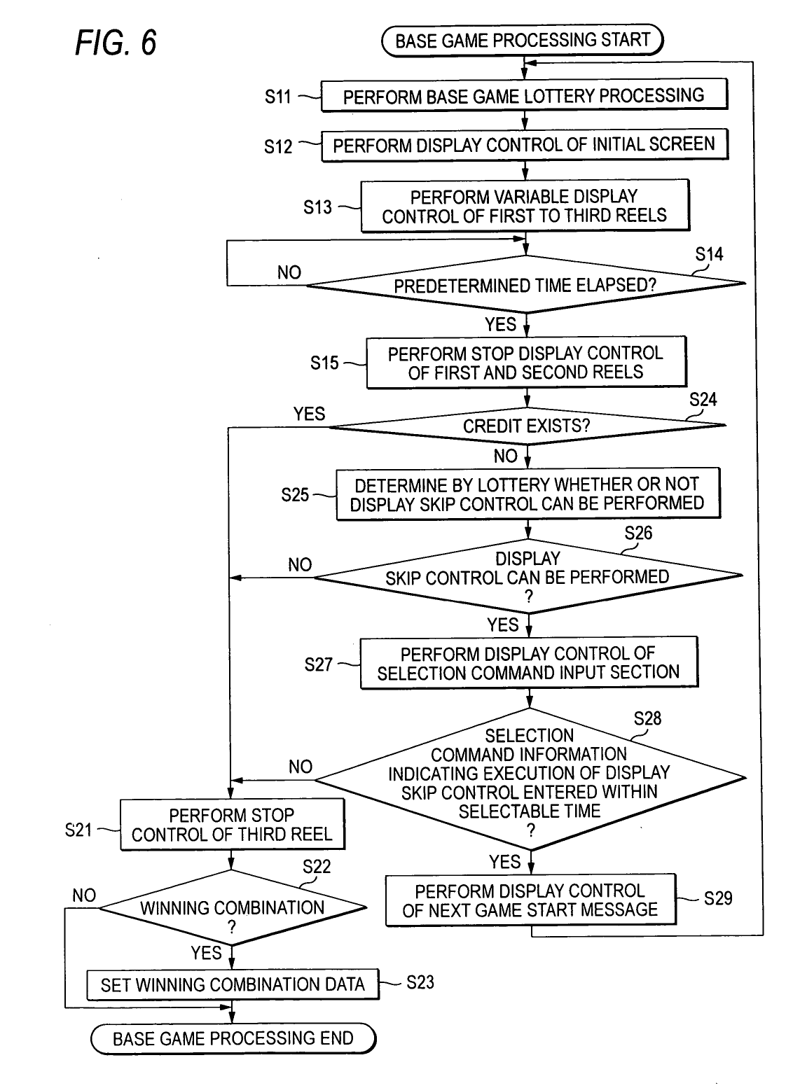

Here, the stop table 90 is a table having a code number area 90a storing the (symbol) code numbers and a symbol area 90b storing the symbols corresponding to the code numbers, as shown in FIG. 7. The code number area 90a can be searched for the stop symbol on each of the symbol display sections 20a, 20b, and 20c with the code number set as a search key (in FIG. 6, “R1,” “R2,” and “R3 correspond to the symbol display sections 20a, 20b, and 20c respectively). The symbol (image representing a face of a doll, joker) corresponding to code number 0 on the symbol display section 20a, 20b, and 20c is more advantageous than other symbols to the player, and when the joker symbol is displayed stopped on the symbol display section 20a, 20b, and 20c, the player notices that the base game transitions to a bonus game.

In the slot machine 1, the random number extraction and search of the symbol determination table and the stop table 90 are performed three times in total for each of the symbol display sections 20a, 20b, and 20c. That is, a table search is made as many times as the number of the symbol display sections 20a, 20b, and 20c, whereby the stop symbols on the symbol display sections 20a, 20b, and 20c are determined. When each stop symbol is determined, the symbols to be placed above and below the stop symbol are also determined and finally three longitudinal 3-symbol rows are determined.

When the stop symbols on the symbol display sections 20a, 20b, and 20c are determined, the main CPU 32 references a win determination table stored in the ROM 34 and determines whether or not the stop symbol combination is a winning combination. Each combination of three symbols displayed stopped on the activated pay line of the symbol display sections 20a, 20b, and 20c (which will be hereinafter referred to as “symbol pattern”) is registered in the win determination table as a winning symbol pattern or a non-winning symbol pattern in association with code number combination (code number pattern). Since the code number patterns corresponding to the stop symbols are already determined, the main CPU 32 operates as a win determination unit, sets the code number pattern of the symbols corresponding to the activated pay line as a search key, references the win determination table, and determines whether or not the player obtains a winning combination of the slot game from the table reference result.

Subsequently, the main CPU 32 performs winning state determination processing of referencing a state table and determining a winning state (winning combination). The combination table is a table for determining a winning state, wherein awards corresponding to winning states are registered. When the winning state determination processing terminates, the base game lottery processing terminates. Then, the process proceeds to step S12 and display control of an initial screen is performed. At this time, the main CPU 32 instructs the video control circuit 71 to display the skip command input section 21 and the point display section 22 together with the symbol display sections 20a, 20b, and 20c on the main display 3. Although not shown in the figure, an image (message image) indicating a message for notifying the player of the start of a slot game (for example, “game start!!”) is also displayed on the initial screen.

In the slot machine 1, when the player touches the skip command input section 21, from start operation of the player in the start acceptance processing at step S1 to stop display control of the third reel at step S20 described later, skip command is input from the touch panel 3a to the main CPU 32.

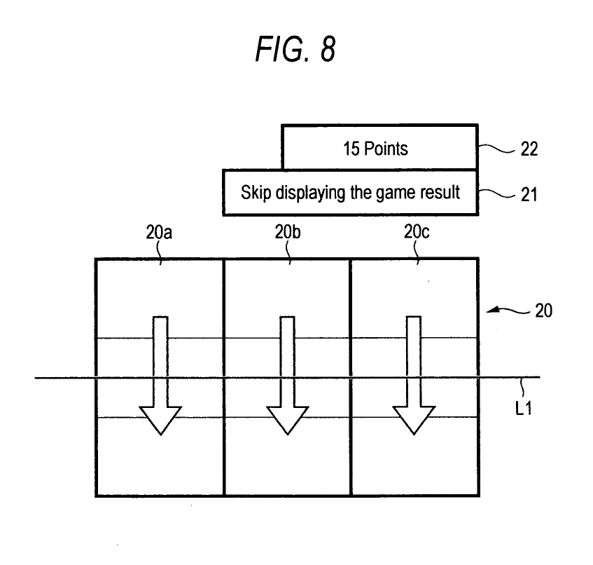

Next, the process proceeds to step S13. When variable display control of the first to third reels is performed, a slot game image indicating execution of a slot game is displayed on the main display 3. The slot game image is an image having the symbol display sections 20a, 20b, and 20c, the skip command input section 21, and the point display section 22 wherein a plurality of symbols are variably displayed on the symbol display sections 20a, 20b, and 20c (each arrow in the longitudinal direction indicates that the symbols are being variably displayed on the symbol display sections 20a, 20b, and 20c), as shown in FIG. 8. An image indicating a character string of “skip displaying the game result” is displayed on the skip command input section 21. The image display on the skip command input section 21 notifies the player that the skip command input section 21 is an operation button for skipping the display of the game result (result of the game). An image indicating the value of “game points” (described later) obtained by the player (in FIG. 8, indicating that the game points are 15) is displayed on the point display section 22.

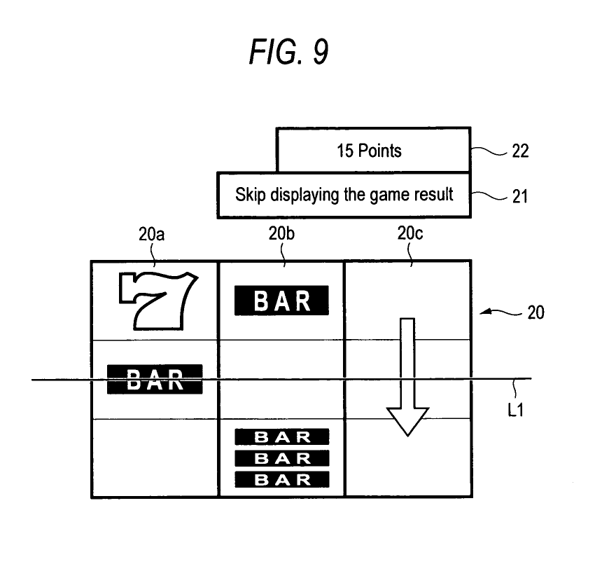

At step S14, the process waits until the expiration of a predetermined time. After the expiration of the predetermined time, the process proceeds to step S15 and stop display control of the first and second reels is performed. At this time, the main CPU 32 instructs the video control circuit 71 to decrease the symbol scrolling speed and display symbol rows with the stop symbols corresponding to the result of the base game lottery processing at step S11 placed at the center in the longitudinal direction on the symbol display sections 20a and 20b as the first and second reels. At this time, for example, a symbol row with “7,” “BAR,” and space arranged from the top to the bottom and a symbol row with “BAR,” space, and “3BAR” (longitudinally arranged character strings of triple “BAR”) arranged from the top to the bottom are displayed on the symbol display sections 20a and 20b as shown in FIG. 9.

At step S16, the main CPU 32 determines whether or not skip command is input from the touch panel 3a within a predetermined time. If skip command is input within the predetermined time (in this case, the player touches the skip command input section 21 within the predetermined time), the process proceeds to step S17; if skip command is not input, the process skips step S17 and goes to step S21. At step S17, the main CPU 32 operates as remainder determination unit for determining whether or not the remainder of credit (game value information) to start the next slot game (next game) exists. If the main CPU 32 determines that the remainder of credit exists, the main CPU 32 operates as display skip control unit. Then, the main CPU 32 executes steps 18 to 20 and then returns to step S11 for performing display skip control as described later. If the main CPU 32 determines that the remainder of credit does not exist, the main CPU 32 skips steps 18 to 20 and goes to step S21.

At step S18, the main CPU 32 operates as update means and performs point addition processing of adding predetermined points to the game points for updating the game points. At step S19, the main CPU 32 operates as point display control unit, performs point display control processing, and instructs the video control circuit 71 to display an image indicating the game points of the result of the addition processing at step S18 on the point display section 22. At step S20, subtraction processing of credit used for restarting base game is performed.

At step S21, in the symbol display section 20c as the third reel during scrolling, the scrolling speed is reduced and a symbol row where the stop symbol corresponding to the result of the base game lottery processing at step S11 is placed at the center in the longitudinal direction is displayed. After execution of step S21, the process proceeds to step S22 and whether or not the player obtains a winning combination in the slot game is determined based on the result of the base game lottery processing at step S11. If it is determined that the player obtains a winning combination, the process proceeds to step S23 and winning combination data indicating the winning combination description responsive to the winning state is set based on the results of the base game lottery processing; if it is not determined that the player obtains a winning combination, the base game processing is terminated without executing step S23.

When the stop symbol is displayed on the symbol display section 20c, the result of the game is displayed on the three symbol display sections 20a to 20c. Since the result of the game is displayed based on the results of the base game lottery processing, the player can recognize the determination result of a winning combination of the slot game according to the display of the result of the game.

The “game points” described herein are “valuable information” (information that indicates valuable index obtained by the player in the game) used in the game performed in the slot machine 1, and is used for returning profits to the player. In the slot machine 1 according to the embodiment, the game points are used by the player for exchanging the game points with commodities such as drinks, original goods, and variety of services, in a game arcade where the slot machine 1 is installed. The game points may be used to be exchanged with a chance to start performing the bonus game such as a free game, or may be used for paying out several percent of betted coins to the player. In using the game points for exchange for the commodity or service, for example, a ticket printer (not shown) is installed in the slot machine 1 and a ticket with game points printed thereon may be output from the ticket printer, and the profits may be returned to the player in the game arcade based on the points printed on the ticket. The timing at which the profits are returned may be the timing at which a transition is made to a bonus game or may be when the player performs operation of terminating variable display game. The game points are used aside from the game value information to start a game.

At step S18 described above, the game points are updated by performing the point addition processing, but may be updated by performing point subtraction processing of subtracting predetermined points from preset initial points. In this case, the game points are also used to return the profits to the player; when the initial points become 0 or a predetermined returnable value, the player is enabled to exchange the points for a commodity or service. For example, when the initial points are 1000, 50 points at a time are subtracted from the initial points and when the initial points become 0 or 100 (returnable value), the player is enabled to exchange the points for a commodity or service.

As described above, when the process returns from step S20 to step S11, the main CPU 32 operates as the display skip control unit for performing display skip control of starting the next game without producing display of the result of the game on the symbol display sections 20a to 20c. As the display skip control is performed, the next slot game is started in a state in which symbols are being scrolled on the symbol display section 20c although stop symbols are displayed on the symbol display sections 20a and 20b. In the slot machine 1, however, the display skip control is performed only when credit remains. If the remaining credit when step S17 is performed is less than the credit count required for activating the activated pay line activated in the preceding slot game, the main CPU 32 again performs processing of activating the activated pay line in the range of the remaining credit (for example, if the remaining credit is only one credit (point) although activated pay lines L1 to L3 are activated, only the activated pay line L1 is activated).

When the base game processing is terminated, the subroutine returns to step S3 of the main routine in FIG. 4 and the main CPU 32 operates as transition determination unit and determines whether or not a transition condition is satisfied and a transition is to be made to the bonus game state from the result of the symbol determination processing in the base game lottery processing. When the transition condition is satisfied, namely, when the symbol to be displayed stopped on the activated pay line L on any of the symbol display section 20a, 20b, or 20c is determined to be a joker, the main CPU 32 determines that a transition can be made to the bonus game state (in addition, whether or not a transition condition is satisfied may be determined by a specific symbol combination).

At this time, a stop display image of a joker and an image indicating a message of “GET THE SPECIAL BONUS!!” are displayed at least on any one of the symbol display section 20a, 20b, or 20c on the main display 3 and on the other hand, the main CPU 32 operates as transition means for causing the game state to make a transition to the bonus game state. When the game state transitions to the bonus game state, the process proceeds to step S4 and bonus game processing is performed. In the bonus game processing, a free game wherein lottery processing of determining the stop symbols on the symbol display sections 20a, 20b, and 20c, variable display processing, and stop display control are performed without operation of the player is performed a predetermined number of times (the number of times may be a predetermined number of times or may be determined in the base game lottery processing). When the bonus game processing terminates, the process proceeds to step S5 and payout processing is performed. The main processing is now complete.

In the slot machine 1, the final display of the result of the game becomes apparent when the stop symbol on the symbol display section 20c is displayed in succession to display of the stop symbols on the symbol display sections 20a and 20b. However, when the stop symbols on the symbol display sections 20a and 20b are displayed, it may be clear that the final display of the result of the game does not meet player's expectations without seeing the stop symbol on the symbol display section 20c. For example, as shown in FIGS. 8 and 9, when activated pay line L1 is set, the stop symbols on the symbol display sections 20a and 20b become as shown in FIG. 9, whereby the display of the result of the game on the activated pay line L1 does not become a specific stop display state indicating coin payout or a transition to a bonus game (for example, the stop symbols on the symbol display sections 20a, 20b, and 20c become “BAR,” “BAR,” and “BAR” or “7,” “7,” and “7” or the like) regardless of the stop symbol on the symbol display section 20c.

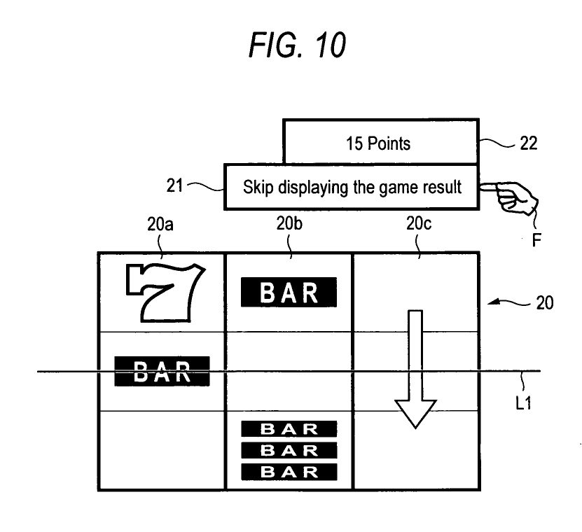

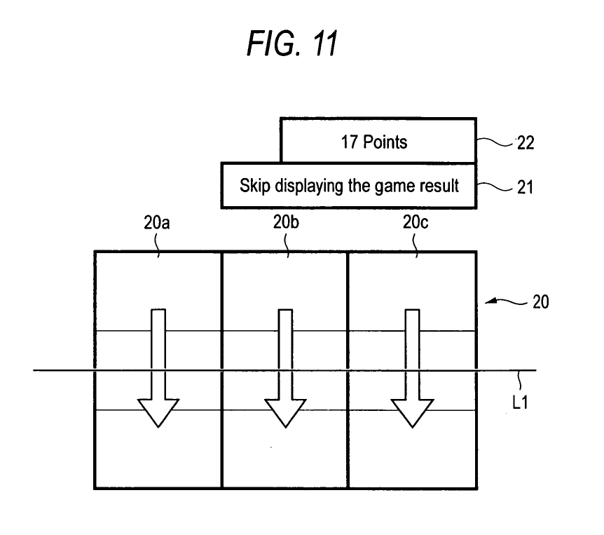

In such a case, the player may touch the skip command input section 21 with a finger F as shown in FIG. 10 before completion of displaying the result of the game (in the embodiment, from display of the stop symbols on the symbol display sections 20a and 20b to display of the stop symbol on the symbol display section 20c). In so doing, as described above, skip command is input from the touch panel 3a to the slot machine 1 (main CPU 32), whereby steps 18 to 20 are performed and the process returns to step S11 without executing steps 21 to 23 and steps 11 to 13 are performed in order. Thus, variable display on the symbol display sections 20a, 20b, and 20c is again produced for the player to play the next slot game, as shown in FIG. 11. In this case, predetermined points are added to the game points and “17” is displayed on the point display section 22.

Thus, when the stop symbols are displayed on the symbol display sections 20a and 20b as the first and second reels, the player can touch the skip command input section 21 with a finger, etc., for starting the next game without producing the final display of the result of the game based on the stop display on the symbol display section 20c.

Thus, in the slot machine 1, when the stop symbols on the symbol display sections 20a and 20b are displayed before completion of displaying the result of the game, if it is clear that the final display of the result of the game does not meet player's expectations without seeing the stop symbol on the symbol display section 20c, the player can start the next game without seeing the final display of the result of the game. Therefore, the player can circumvent a sense of loss or disappointment caused by the disappointing display of the result of the game. Moreover, as the final display of the result of the game is skipped, operation availability (operating rate) of the slot machine 1 can be improved.

To execute display skip control, the slot machine 1 requests the player to touch the skip command input section and thus promotes active operation of the player and allows the player to actively play a game with the game play desire. In addition, the player is requested to determine whether or not display skip control is to be performed, so that the player can be made strongly conscious of the result of the game and player's interest in game play can be more enhanced.

Further, when display skip control is performed, game points are added. Since the game points are used to return the profits to the player, the profits returned to the player can be increased as the game points are added. In so doing, the player can feel that he or she obtains profit by executing display skip control to display the result of the game.

Since the display skip control is performed only when the remainder of credit exists, the player can be prevented from playing a slot game although the remainder of credit does not exist.

### SECOND EMBODIMENT

Next, a slot machine 1 in a second embodiment will be discussed. The slot machine 1 in the embodiment differs from the slot machine 1 in the first embodiment in base game processing.

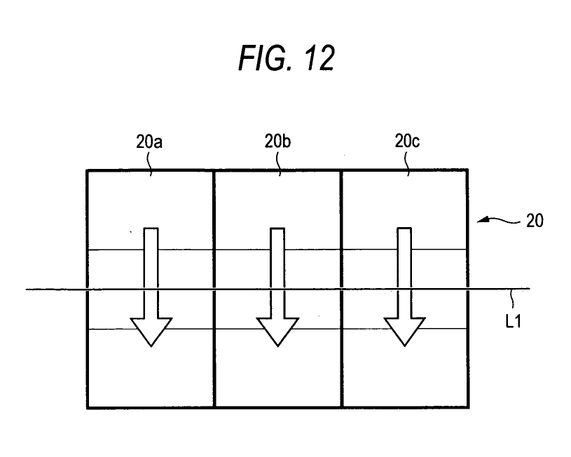

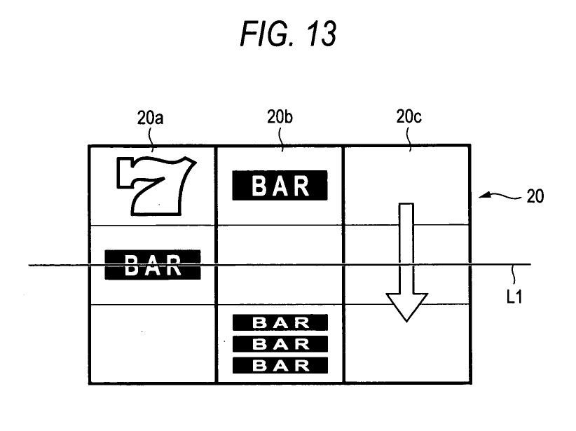

That is, in the slot machine 1 in the second embodiment, steps 11 to 15 are performed as in the first embodiment and then the process proceeds to step S24. However, when display control of an initial screen is performed at step S12, a skip command input section 21 and a point display section 22 are not displayed although symbol display sections 20a to 20c and a message image are displayed. Thus, when variable display control processing of first to third reels is started, a slot game image is displayed on a main display 3 as in FIGS. 12 and 13.

Next, at step S24, whether or not the remainder of credit exists is determined as at step S17 in the first embodiment. If it is determined that the remainder of credit exists, the process proceeds to step S25; if it is not determined that the remainder of credit exists, the process proceeds to step S21 and similar processing to that in the first embodiment is performed.

At step S25, the main CPU 32 operates as execution determination unit and refers to an execution determination table (a table storing information indicating execution or no-execution, and random numbers in a predetermined range in association with each other—not shown) using an extracted random number and determines by lottery whether or not display skip control can be performed for allowing the player to start the next play without producing play result display on the symbol display sections 20a to 20c. At step S26, the lottery result at step S25, namely, whether or not display skip control can be performed is determined. When it is determined at step S25 that display skip control can be performed, the process proceeds to step S27; when it is not determined that display skip control can be performed, the process proceeds to step S21 and similar processing to that in the first embodiment is performed.

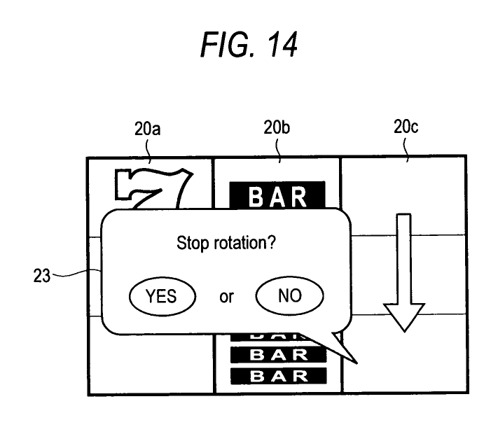

Next, at step S27, the main CPU 32 operates as notification control unit and instructs a video control circuit 71 to display a selection command input section 23 on the main display 3. Accordingly, the selection command input section 23 is displayed across the symbol display sections 20a to 20c, as shown in FIG. 14. At step S28, whether or not the player has entered selection command information (execution command information) indicating execution of display skip control within selectable time described later is determined.

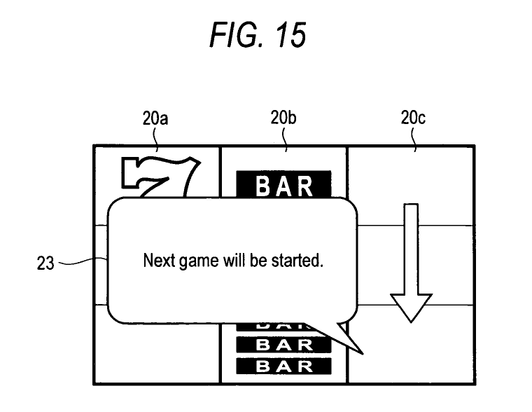

When the player has entered execution command information within the selectable time, the process proceeds to step S29; if the player has entered non-execution command information within the selectable time, the process proceeds to step S21 and similar processing to that in the first embodiment is performed. If the process proceeds to step S21 from step S28, the main CPU 32 operates as display control unit for performing third-reel stop control to display the result of the game. Therefore, when non-execution command information is entered or when execution command information is entered exceeding the selectable time, a stop symbol is displayed on the symbol display section 20c and the result of the game is displayed. At step S29, the main CPU 32 instructs the video control circuit 71 to perform display control of a next game start message for displaying a starting-next-game-message image 24 across the symbol display sections 20a to 20c, as shown in FIG. 15.

The selection command input section 23 displays an image indicating a message of “stop rotation?” and a message of “YES or NO” as shown in FIG. 14, notifying the player that he or she can select execution or non-execution of display skip control. If the player touches the part of “YES” or the part of “NO”, selection command information (non-execution command information) indicating non-execution of display skip control or selection command information (execution command information) indicating execution of display skip control is input to the main CPU 32 from a touch panel 3a as selection command information. In this case, the touch panel 3a implements selection command input unit.

The selectable time is a predetermined time for allowing the player to touch the part of the touch panel 3a corresponding to the selection command input section 23, for entering selection command information as selection command input.

The starting-next-game-message image 24 is an image indicating a message of “next game will be started” The starting-next-game-message image 24 is displayed while symbols are being variably displayed on the symbol display section 20c although scroll display stops on the symbol display sections 20a and 20b, notifying the player that the next game will be started without stopping the third reel. FIG. 15 corresponds to the case where the player touches the part of “NO”, in FIG. 14.

As described above, in the slot machine 1 in the embodiment, the main CPU 32 as the execution determination unit determines whether or not display skip control can be performed and when it is determined that display skip control can be performed, the play can select execution or non-execution of display skip control. Therefore, in the slot machine 1 in the embodiment, whether or not stop display of the third reel can be skipped by the display skip control is determined by lottery and thus stop display of the third reel cannot always be skipped. If it is determined that display skip control can be performed, the player is given the occasion of selecting skip or no skip of stop display of the third reel, and display skip control is performed according to selection of the player. Thus, player's interest in the lottery result as to whether or not stop display of the third reel can be skipped can be more attracted for enhancing interest in game play. The player can select execution or non-execution of display skip control only within the predetermined selectable time, so that the fruitless time during which processing does not proceed can be eliminated for improving the operation availability of the game play.

In the slot machine 1 according to the embodiment, the main CPU 32 operates as notification control unit for notifying the player that execution or non-execution of display skip control can be selected on the main display 3, but the player may be notified by audio output to speakers 12L and 12R rather than on the main display 3.

### MODIFIED EXAMPLE

In the embodiments described above, three symbol display sections are provided, but the number of the symbol display sections is not limited to three and may be five or nine.

The touch panel 3a is used as the skip command input section, but the skip command input section may be any other than the touch panel 3a. For example, a pedestal portion 11 may be provided with an operation button functioning as skip command input section for the player to enter skip command into the main CPU 32 by operating the operation button.

In the embodiments described above, the gaming machine is described by taking the slot machine 1 for allowing the player to play a slot game as an example, but the present invention can also be applied to a card gaming machine for displaying a card image representing playing cards and allowing the player to play a card game of poker, black jack, etc. The invention can be applied not only to the slot machine for variably displaying symbols, but also to a pachinko machine and a Pachi-Slot machine.

Further, the functions of the first and second embodiments may be used in combination or the determination as to whether or not skip command is input for executing display skip control (step S16 in FIG. 5) or the display skip control execution determination by lottery (step S26 in FIG. 6) may be performed after the first reel stops. The display skip control execution lottery (step S25 in FIG. 6) may be performed at the same timing as the base game lottery processing at step S11 (before step S12), for example, and the timing of the display skip control execution lottery is not limited to the timing mentioned above and can be set appropriately.

The foregoing description of the embodiment has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

What is claimed is:

1. A gaming machine comprising:
an image display device;
a processor that performs a process for providing a player a game by controlling the image display device to display a progress of the game; and
an operation unit that allows the player to input skip command,
wherein the processor performs the process comprising:
determining whether or not a win by the player occurs in the game;
controlling the image display device to perform a game result displaying process for displaying a result of the game in accordance with the determination to allow the player to recognize the result of the determination; and
controlling the image display device to cancel performing the game result displaying process before completion thereof, and to start performing a next game, when the skip command is input through the operation unit.

2. The gaming machine according to claim 1, wherein the processor performs the process further comprising performing a lottery for determining whether or not the win occurs.

3. The gaming machine according to claim 1, wherein the processor performs the process further comprising:
performing a lottery to determine a stop sate of symbols;
controlling the image display device to perform variable display for variably displaying a plurality of symbols on each of a plurality of symbol display sections configured on a screen of the image display device;
controlling the image display device to perform the game result displaying process that includes stop performing the variable display and to display the symbols in the stop state determined by the lottery, after an expiration of a predetermined time from the start of the variable display;
determining an occurrence of the win in the game when a symbol combination, which is a combination of symbols being stopped in a determination area defined by a part of the symbol display sections, satisfies a winning combination; and
performing a payout of an award to the player when the occurrence of the win is determined.

4. The gaming machine according to claim 1, wherein the operation unit includes a mechanical switch that outputs the skip command when operated by the player.

5. The gaming machine according to claim 1, wherein the operation unit includes a touch panel device that is disposed on a screen of the image display device and outputs the skip command when operated by the player.

6. The gaming machine according to claim 1, wherein the operation unit is configured to be activated while the game is performed, and allows the player to select one from a first mode in which the skip command is output and a second mode in which the skip command is not output.

7. The gaming machine according to claim 1, wherein the operation unit is configured to be activated when the processor determines that the win will not occur in the game.

8. The gaming machine according to claim 7, wherein the operation unit is configured to be activated in accordance with a lottery performed by the processor.

9. The gaming machine according to claim 7, wherein the operation unit is configured to be activated for a predetermined time period.

10. The gaming machine according to claim 1, wherein the processor performs the process for providing the player the game in exchange for a predetermined amount of credit point, and
wherein the operation unit is activated when a remaining amount of credit point owned by the player is equal to or larger than the credit point necessary for performing the game.

11. The gaming machine according to claim 1, wherein the processor performs the process further comprising updating a value of game point owned by the player when the game result displaying process is cancelled, the game point used for returning profits to the player.

12. A method for providing a player a game with a gaming machine by controlling an image display device provided on the gaming machine to display a progress of the game, the method comprising:
determining whether or not a win by the player occurs in the game;
controlling the image display device to perform a game result displaying process for displaying a result of the game in accordance with the determination to allow the player to recognize the result of the determination; and
controlling the image display device to cancel performing the game result displaying process before completion thereof, and to start performing a next game, when a skip command is input through an operation unit provided on the gaming machine.

13. A computer-readable program product for causing a computer provided on a gaming machine for providing a player a game to control an image display device provided on the gaming machine to display a progress of the game, the program product causing the computer to perform a procedure comprising:
determining whether or not a win by the player occurs in the game;
controlling the image display device to perform a game result displaying process for displaying a result of the game in accordance with the determination to allow the player to recognize the result of the determination; and
controlling the image display device to cancel performing the game result displaying process before completion thereof, and to start performing a next game, when a skip command is input through an operation unit provided on the gaming machine.
